(19) United States
(12) Patent Application Publication
(10) Pub. No.: US 2009/0266445 A1
(43) Pub. Date: Oct. 29, 2009

(54) Work Bench for a Hand Jointer

(76) Inventor: Lee-Cheng Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/110,387

(22) Filed: Apr. 28, 2008

(51) Int. Cl. B25H 1/14

(52) U.S. Cl. 144/286.5; 144/287

(57) ABSTRACT

A work bench for a hand jointer, the work bench comprises a base assembly, two micro-adjusting assemblies installed to the base assembly and first and second granite jointer tables respectively disposed on the micro-adjusting assemblies, with the bottom of the first and second granite jointer tables respectively in contact with the top surface of micro-adjusting assemblies; wherein the horizontal positions of the first and second granite jointer tables relative to each other are adjustable via the micro-adjusting assemblies.

### BACKGROUND OF THE INVENTION

1. Field of the Invention

The present invention relates to a work bench for a hand jointer.

2. Description of the Related Art

A hand jointer is one of a kind of wood making machine tools. The hand jointer allows a user to form a precise angle between two surfaces on a workpiece, usually a wood board to be used in a final product such as furniture, cabinetry, and the like.

A conventional hand jointer is usually attached with a work bench for placement of wood-board workpieces. However, a jointer table of the work bench is usually made of metal material like cast-iron, die-cast aluminum and soon.

No matter which metal material the jointer table is made of, the shortcomings of the metal jointer table are instability and properties of wear resistance. Therefore, this kind of jointer table is easy to be influenced via temperature and humidity. It causes higher cost of maintenance.

Moreover, the jointer table is usually manufactured to be in form of a thick board with huge length and depth and integrally combined with a base assembly of the conventional hand jointer. Because the material and the volume of the jointer table, it is not easy to keep the surface of the jointer table being level for placement of wood-board workpieces during operation. In addition, suppose the surface of the jointer table should become not level, the conventional hand jointer is hard to be adjusted to make the jointer table to return the level condition.

The present invention is therefore intended to obviate or at least alleviate the problems encountered in prior art.

### SUMMARY OF THE INVENTION

It is therefore an object of the present invention to provide a work bench for a hand jointer that is adapted for smoothly movement of a workpiece thereon, and a jointer table of the work bench is made of granite for a stable operation.

Accordingly, the present invention provides a work bench for a hand jointer including a base assembly, two micro-adjusting assemblies and first and second granite jointer tables. Each of the micro-adjusting assemblies includes a support, two flat pieces and a plurality of first inserted elements. Each of the first inserted elements is disposed on the top surface of the support and adapted to adjust the horizontal position each of the flat pieces. Each of the flat pieces is in contact with the first and second granite jointer tables so that in the meanwhile, the horizontal positions of the first and second granite jointer tables relative to each other are adjusted.

An advantage to the present invention is that the jointer tables of the work bench are made of granite.

Another advantage to the present invention is that the horizontal positions granite jointer tables relative to each other can be adjusted easily.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a perspective view of a work bench for a hand jointer according to the preferred embodiment of the present invention.

FIG. 2 is an exploded view of the work bench shown in FIG. 1.

FIG. 3 is a cross-sectional view taken along 3-3 in FIG. 1, illustrating location of the fence assembly with respect to the granite jointer tables.

FIG. 4 is a partial, enlarged view of the micro-adjusting means in FIG. 3.

FIG. 5 is another enlarged view of the micro-adjusting means in FIG. 3.

### DETAILED DESCRIPTION OF THE PREFERRED EMBODIMENT

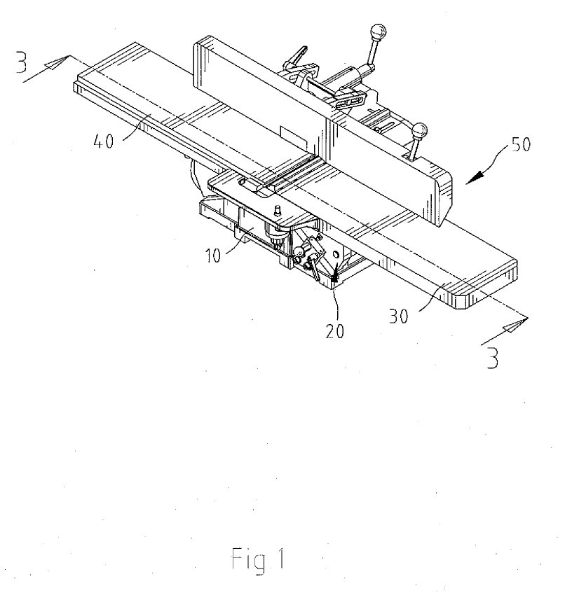

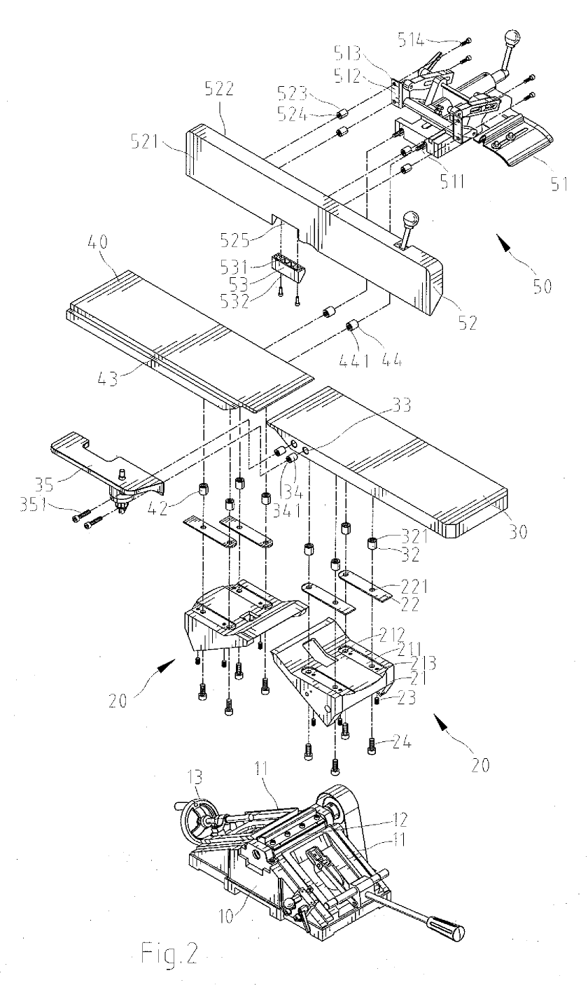

Referring to FIGS. 1 and 2, a work bench for a hand jointer, the work bench includes a base assembly 10, two micro-adjusting assemblies 20, a first granite jointer table 30, a second granite jointer table 40 and a fence assembly 50. The base assembly 10 consists of two inclined plates 11, a blade unit 12 disposed between the inclined plates 11 and a height-adjust unit 13 installed on one of the inclined plates 11. The micro-adjusting assemblies 20 are set over the inclined plates 11, respectively. The height-adjust unit 13 is provided to adjust the height of the first and second granite jointer tables 30 and 40. The horizontal positions of the first and second granite jointer tables 30 and 40 relative to each other can be adjusted via the micro-adjusting assemblies 20 as described in more detail below.

Each of the micro-adjusting assemblies 20 includes a support 21, two flat pieces 22 respectively installed onto the support 21 and two flat pieces 22 attached onto the support 21. The support 21 is made of cast-iron and has a good anti-shake property. Two grooves 211 are respectively formed on two sides of the top surface of the support 21. An end of each of the grooves 211 is open to the edge of the support 21 and another end is closed for easy arrangement of the flat pieces 22 on the grooves 211. A plurality of first and second holes 212 and 213 are defined on each of the grooves 211. A plurality of through-holes 221 are defined on each of the flat pieces 22. First inserted elements 23 are inserted through the second holes 213, respectively, and then abutted against the bottom surface of the flat pieces 22. Each of the first inserted elements 23 is preferably an adjusting screw. Second inserted elements 24 are inserted through the first holes 212 of the support 21 to through-holes 221 of the flat pieces 22. Each of the second inserted elements 24 is preferably a bolt.

The first and second granite jointer tables 30 and 40 are made of granite and preferably in form of a rectangular shape. Granite is a common and widely occurring type of intrusive, felsic, igneous rock. Granite has a medium to coarse texture, occasionally with some individual crystals larger than the groundmass forming a rock known as porphyry. Granite is nearly always massive (lacking internal structures), hard and tough, and therefore it has gained widespread use as a construction stone. Once granite is manufactured to a finished product, the granite product would not be easily deformed or depressed. The average density of granite is 2.75 g/cm³.

Granite is a highly durable siliceous stone. Compared to marble, it is more resistant to the acids found in lemons, vinegars, and cleaning products and usually will not etch. It is an easy stone to live with.

Granite characteristics make this stone virtually scratch proof. It will not scratch even when directly cut on. Things such as keys, coins, utensils, and appliances won't scratch it either.

Granite will actually dull your knives. Little slivers of the knife can become embedded in your stone. This is very noticeable with the darker stones so make a note if you are using your stone as a cutting board.

The characteristics of granite also make this stone heat resistant. It can withstand heat up to 1200 degrees Fahrenheit. Users won't have to worry about any burn or char marks.

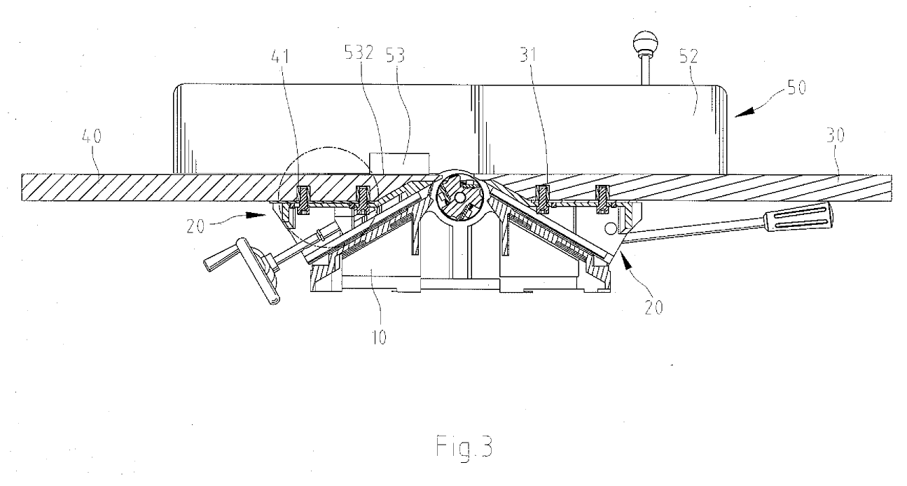

A plurality of first recesses 3 1 and 41 are defined on the bottom surface of the first and second granite jointer tables 30 and 40, respectively (as shown in FIG. 3). First blocks 32 and 42 are buried in the first recesses 31 and 41, respectively. The first blocks 32 and 42 respectively form threaded holes 321 and 421 therein. The first and second granite jointer tables 30 and 40 directly abut with the support 21 and the flat pieces 22 of the two micro-adjusting assemblies 20, respectively.

In addition, the threaded holes 321 and 421 correspond to the through-holes 221 of the flat pieces 22, respectively, and hence the second inserted elements 24 are inserted through the first holes 212 of the support 21 and the through-holes 221 of the flat pieces 22 to engage with the threaded holes 321 and 421 of the first and second granite jointer tables 30 and 40.

Several second recesses 33 are formed on a sidewall of the first granite jointer table 30. A second block 34 is provided to be buried in each of the second recesses 33. A threaded hole 341 are defined in the second block 34. An extension plate 35 is installed onto the sidewall of the first granite jointer table 30 abutting with the second recesses 33 and includes two fasteners 351 that couple with the second blocks 34, respectively. A stepped-form abutted surface 43 is formed on a sidewall of the second granite jointer table 40 adjacent to the extension plate 35 of the first granite jointer table 30 and allows the extension plate 35 abutting therewith. The extension plate 35 is preferably made by aluminum die casting or punching. Two second blocks 44 are buried onto another sidewall of the second granite jointer table 40 opposite to the extension plate 35. A threaded hole 441 is formed in each of the second blocks 44.

The fence assembly 50 includes a fence adjusting means 51, a fence body member 52 and a fence positioning cushion 53. Two coupled elements 511 are disposed on a side of the bottom of the fence adjusting means 51 and respectively coupled to the second blocks 44 of the second granite jointer table 40. Two connected portions 512 are defined on a side of the fence adjusting means 51, and each of the connected portions 512 includes several through-holes 513 formed thereon.

The fence body member 52 includes a first side 521 and a second side 522 opposite to the first side 521. The first side 521 is a smooth and flat surface and adapted to contact with a side of a workpiece that is prepared for process. The position of the fence body member 52 can be adjusted via the fence adjusting means 51, and accordingly, the position of the workpiece that is prepared for process can be adjusted simultaneously.

Several blocks 523 are buried into the second side 522, and each of the blocks 523 has a threaded hole 524 therein. A fastener 514 is adapted for inserting through one of the through-holes 513 to engage with the related block 523 for attachment of the fence adjusting means 51 and the fence body member 52. A yawn 525 is provided on the bottom of the fence body member 52.

The fence positioning cushion 53 is received in the yawn 525 of the fence body member 52 and includes a coupled side 531 on the top thereof and a tapered cushion side 532 opposite to the coupled side 531. The coupled side 531 is engaged with the inner wall of the yawn 525 via a plurality of fasteners (not numbered). The fence positioning cushion 53 is preferably made of plastic.

Referring to FIG. 3, the fence body member 52 is not directly in contact with the first and second granite jointer tables 30 and 40. The tapered cushion side 532 of the fence positioning cushion 53 is provided between the fence body member 52 and the first and second granite jointer tables 30 and 40. Accordingly, the plastic fence positioning cushion 53 would not wear or break the surface of the first and second granite jointer tables 30 and 40 by movement or pressure thereon.

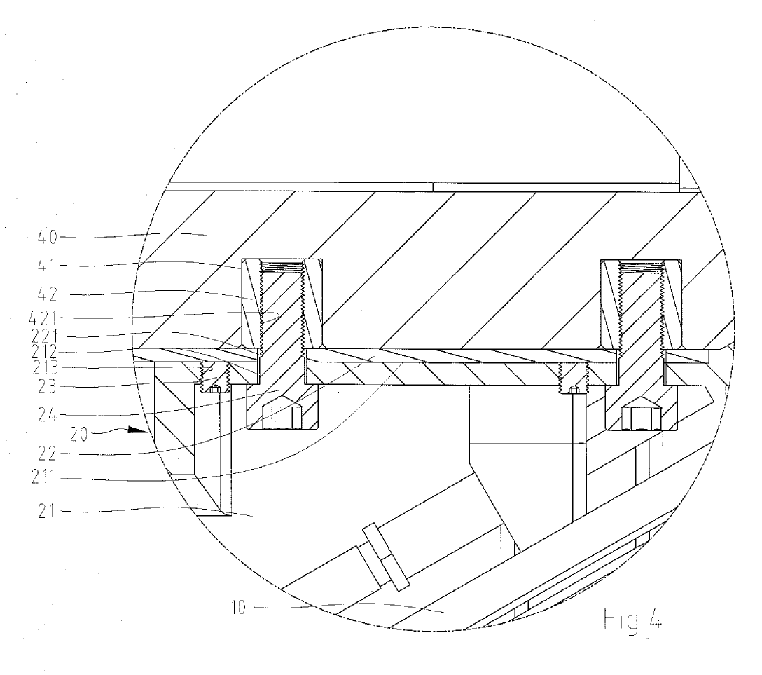

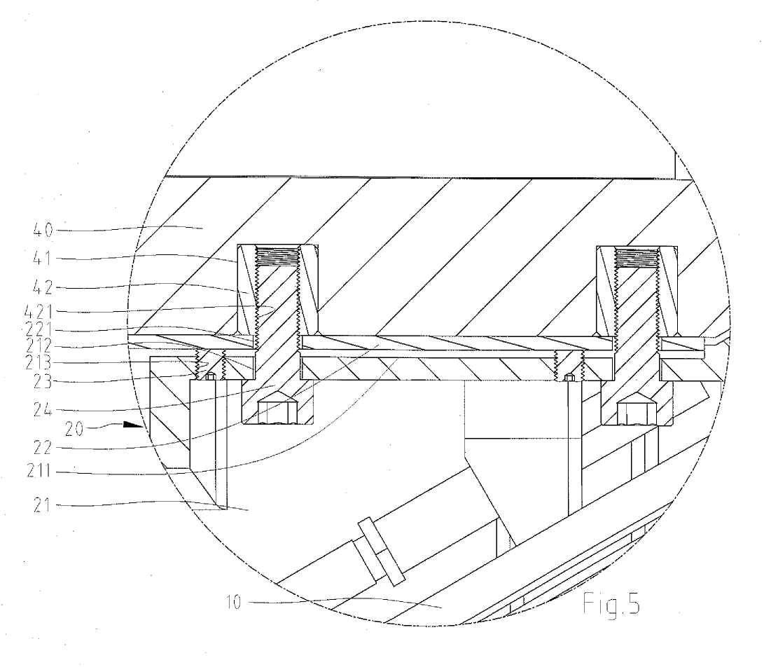

Referring to FIGS. 4 and 5, the first and second granite jointer tables 30 and 40 are respectively fixed onto the two micro-adjusting assemblies 20 via the second inserted elements 24 engaged with the first blocks 32 and 42 of the first and second granite jointer tables 30 and 40. The first inserted elements 23 are engaged to the support 21 and in contact with the bottom surface of the flat pieces 22. Users can adjust each of the first inserted elements 23 to push the bottom surface of the flat pieces 22 for detachment of each of the flat pieces 22 from the related groove 211 of the support 21. Therefore, each of the flat pieces 22 would press upwardly to the first and second granite jointer tables 30 and 40, and it can adjust the horizontal positions of the first and second granite jointer tables 30 and 40 relative to each other.

What is claimed is:

1. A work bench for a hand jointer, the work bench comprising:
a base assembly;
two micro-adjusting assemblies installed to the base assembly;
first and second granite jointer tables respectively disposed on the micro-adjusting assemblies, with the bottom of the first and second granite jointer tables respectively in contact with the top surface of micro-adjusting assemblies;
wherein the horizontal positions of the first and second granite jointer tables relative to each other are adjustable via the micro-adjusting assemblies.

2. The work bench as claimed in claim 1, wherein each of the micro-adjusting assemblies further comprises a support and at least one of flat pieces installed onto the top surface of the support.

3. The work bench as claimed in claim 2, further comprising at least one of grooves formed on the top surface of the support, with the at least one of grooves provided for receiving the at least one of flat pieces.

4. The work bench as claimed in claim 3, further comprising at least one of second holes formed on each groove and at least one of first inserted elements adapted to insert through the related one of the second holes and abutting with the bottom surface of the related flat piece, with the at least one of first inserted elements adapted for adjustment of the horizontal positions of the first and second granite jointer tables relative to each other.

5. The work bench as claimed in claim 3, with an end of each of the grooves being open to the edge of the support and another end that is opposite to the end being closed.

6. The work bench as claimed in claim 3, wherein each of the least one of grooves further comprise a plurality of first holes, and each of the least one of flat pieces comprises a plurality of through-holes, with the through-holes of the flat pieces corresponding to the first holes of the grooves, respectively, with at least one of second inserted elements adapted for inserting through the related first holes of the grooves and the related through-holes of the flat pieces for attachment of the least one of flat pieces and the supports with the first and second granite jointer tables.

7. The work bench as claimed in claim 6, wherein the first and second granite jointer tables further comprise at least one of first recesses formed on the bottom surface thereof, respectively and at least one of first blocks received in the related first recesses, with the at least one of second inserted elements engaged with the related at least one of first blocks.

8. The work bench as claimed in claim 7, with the at least one of first blocks respectively buried in the related first blocks.

9. The work bench as claimed in claim 1, further comprising an extension plate installed onto a sidewall of the first granite jointer table.

10. The work bench as claimed in claim 9, further comprising at least one of second recesses formed on the sidewall of the first granite jointer table, at least one of second blocks received in the related one of the second recesses, and at least one of fasteners disposed on a side of the extension plate and engaged with the related one of the second blocks for fixing the extension plate to the first granite jointer table.

10. The work bench as claimed in claim 1, further comprising a fence assembly installed on a sidewall of the second granite jointer table and including a fence adjusting means and a fence body member coupled to the fence adjusting means.

11. The work bench as claimed in claim 8, further comprising a fence assembly installed on a sidewall of the second granite jointer table opposite to the extension plate and including a fence adjusting means and a fence body member coupled to the fence adjusting means.

12. The work bench as claimed in claim 10, further comprising a fence positioning cushion installed to the bottom of the fence body member, with the positioning cushion having a coupled side defined on the top thereof and a cushion side opposite to the coupled side, with the cushion side in contact with the first and second granite jointer tables.

13. The work bench as claimed in claim 12, with the fence positioning cushion being made of plastic.

14. The work bench as claimed in 11, with the fence adjusting means including at least one of coupled elements on a side of the bottom thereof for coupling to the sidewall of the second granite jointer table.

15. The work bench as claimed in claim 4, with each of the micro-adjusting assemblies having four first inserted elements.
